(19) United States
(12) Patent Application Publication
(10) Pub. No.: US 2026/0346217 A1
(43) Pub. Date: Nov. 5, 2026

(54) MIXING APPARATUS, AND METHOD OF MANUFACTURING MIXTURE

(71) Applicant: KYOCERA CORPORATION, Kyoto (JP)

(72) Inventors: Shinichi SUZUKI, Kyoto (JP); Yuki SHIBUKAWA, Kyoto (JP); Hiroto ITOH, Kyoto (JP); Shigeru MIYAZAKI, Kyoto (JP); Chikara SOEJIMA, Kyoto (JP)

(21) Appl. No.: 19/123,768

(22) PCT Filed: Oct. 27, 2022
(86) PCT No.: PCT/JP2022/040103

§ 371 Date: Apr. 24, 2025

(51) Int. Cl. B01F 25/72; B01F 23/50; B01F 35/71

(52) U.S. Cl. CPC B01F 25/72; B01F 23/54; B01F 35/712; B01F 35/71705; B01F 35/7179

(57) ABSTRACT

A mixing apparatus according to an aspect of the present disclosure includes: a conveyer configured to convey powder; a powder forming mechanism configured to form the powder into a laminar shape; and a liquid spraying mechanism configured to spray liquid to the powder formed into a laminar shape, wherein the powder forming mechanism includes first and second blades configured to form the powder in a height direction with respect to the conveyer, and a height of each of the blades with respect to the conveyer varies during conveyance of the powder by the conveyer.

The present application is a National Phase of International Application No. PCT/JP 2022/040103 filed Oct. 27, 2022

### TECHNICAL FIELD

The present disclosure relates to a mixing apparatus that mixes powder and liquid, and a method of manufacturing a mixture using the mixing apparatus.

### BACKGROUND OF INVENTION

Patent Document 1 discloses a manufacturing apparatus for clad brazing material sheets. The manufacturing apparatus includes a rolling roller that rolls a metal plate and raw material powder having a brazing composition. This apparatus includes a liquid supply apparatus that adjusts the adhesive force between particles making up the raw material powder by supplying liquid to the raw material powder rolled by the rolling roller. The liquid supply apparatus includes a spray nozzle that supplies liquid to the raw material powder conveyed by a belt feeder.

### CITATION LIST

### Patent Literature

Patent Document 1: JP 2009-95871 A

### SUMMARY

A mixing apparatus according to an aspect of the present disclosure includes: a conveyer configured to convey powder; a powder forming mechanism configured to form the powder into a laminar shape; and a liquid spraying mechanism configured to spray liquid to the powder formed into a laminar shape, in which the powder forming mechanism includes a blade configured to form the powder in a height direction with respect to the conveyer, and a height of the blade with respect to the conveyer continuously varies during conveyance of the powder by the conveyer.

A method of manufacturing a mixture according to an aspect of the present disclosure is a method of manufacturing a mixture using a mixing apparatus, the mixing apparatus including: a conveyer configured to convey powder; a powder forming mechanism configured to form the powder into a laminar shape; and a liquid spraying mechanism configured to spray liquid to the powder formed into a laminar shape, the powder forming mechanism including one or more blades configured to form the powder in a height direction with respect to the conveyer, a height of each of the blades with respect to the conveyer varying between a first height and a second height greater than the first height during conveyance of the powder by the conveyer, the method including: conveying the powder by the conveyer; forming the powder being conveyed in the conveying into a laminar shape by the powder forming mechanism; and spraying liquid by the liquid spraying mechanism to the powder formed into a laminar shape in the forming.

### BRIEF DESCRIPTION OF THE DRAWINGS

FIG. 1 is a perspective view illustrating a configuration of a mixing apparatus according to a first embodiment.

FIG. 2 is a plan view illustrating a configuration of the mixing apparatus according to the first embodiment.

FIG. 3 is a sectional view taken along a line III-III in FIG. 2.

FIG. 4 is a sectional view taken along a line IV-IV in FIG. 2.

FIG. 5 is a side view of a cover including a liquid spraying mechanism.

FIG. 6 is a flowchart illustrating an example of a method of manufacturing a mixture using the mixing apparatus according to the first embodiment.

FIG. 7 is a perspective view illustrating a configuration of a mixing apparatus according to a second embodiment.

FIG. 8 is a sectional view illustrating a configuration of a powder forming mechanism provided in the mixing apparatus according to the second embodiment.

FIG. 9 is a plan view illustrating a configuration of a moving mechanism and its surroundings provided in the mixing apparatus according to the second embodiment.

### DESCRIPTION OF EMBODIMENTS

### First Embodiment

An embodiment of the present disclosure is described below in detail. In the following description, the numerical range “A to B” means “equal to or greater than A and equal to or smaller than B” unless otherwise noted.

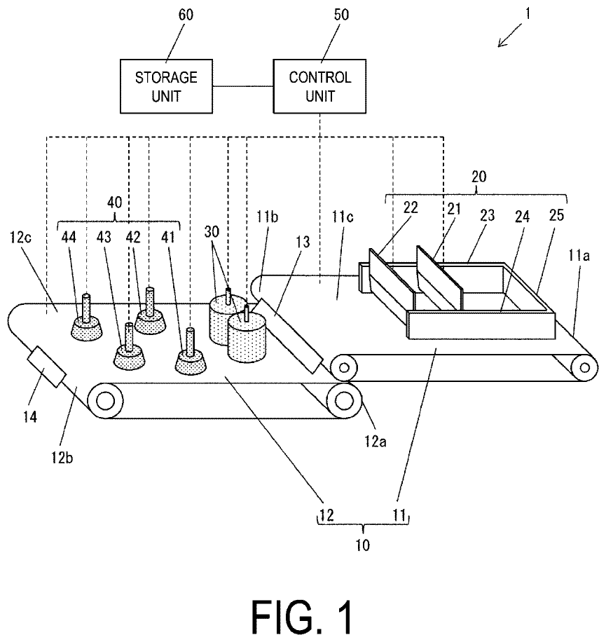

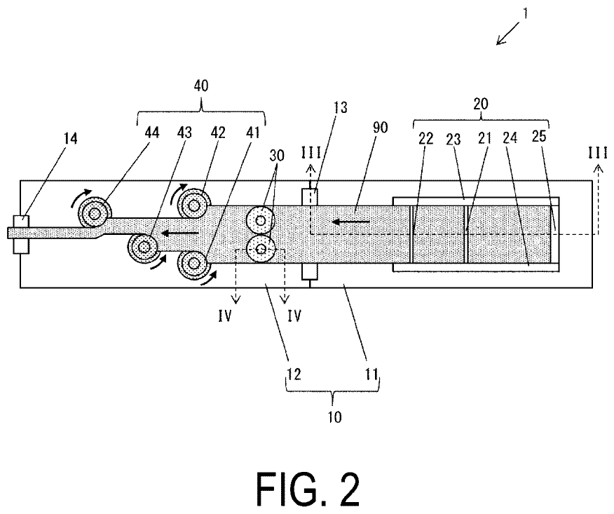

FIG. 1 is a perspective view illustrating a configuration of a mixing apparatus 1 according to a first embodiment. FIG. 2 is a top view illustrating a configuration of the mixing apparatus 1. As illustrated in FIGS. 1 and 2, the mixing apparatus 1 may include a conveyer 10, a powder forming mechanism 20, a liquid spraying mechanism 30, a moving mechanism 40, a control unit 50, and a storage unit 60. In FIG. 2 the control unit 50 and the storage unit 60 are omitted.

The conveyer 10 may be configured to be able to convey powder 90. For simplicity's sake, the powder 90 is omitted in FIG. 1. The powder 90 is, for example, ceramic or other particles. Specific examples of the powder 90 include alumina powder, zirconia powder, and graphite powder.

The conveyer 10 may include a first conveyer 11 and a second conveyer 12. The first conveyer 11 and the second conveyer 12 may be a belt conveyor including an annular belt and a pulley for turning the belt, for example. The conveyance direction of the powder 90 by the first conveyer 11 and the conveyance direction of the powder 90 by the second conveyer 12 may be the same as or different from each other. In particular, in the case where the conveyance direction of the powder 90 by the first conveyer 11 and the conveyance direction of the powder 90 by the second conveyer 12 are the same as each other, the variation in the thickness of the powder 90 when the powder 90 moves from the first conveyer 11 to the second conveyer 12 can be reduced in the direction along the conveyance surface on which the conveyer 10 conveys the powder 90 and in the direction perpendicular to the conveyance direction.

In the following description, the conveyance direction of the powder 90 by the first conveyer 11 and the conveyance direction of the powder 90 by the second conveyer 12 may be referred to as conveyance direction of the powder 90 by the conveyer 10, or simply as conveyance direction. The direction along the conveyance surface on which the conveyer 10 conveys the powder 90 and perpendicular to the conveyance direction may be referred to as width direction.

The first conveyer 11 includes an upstream end portion 11a and a downstream end portion 11b in the conveyance direction, and a conveyance surface 11c that conveys the powder 90 between the upstream end portion 11a and the downstream end portion 11b. The powder forming mechanism 20 is located on the conveyance surface 11c. The second conveyer 12 includes an upstream end portion 12a and a downstream end portion 12b in the conveyance direction, and a conveyance surface 12c that conveys the powder 90 between the upstream end portion 12a and the downstream end portion 12b. The liquid spraying mechanism 30 and the moving mechanism 40 are located in this order in the conveyance direction above the conveyance surface 12c. A region of the second conveyer 12 between the liquid spraying mechanism 30 and the upstream end portion 12a is located below the downstream end portion 11b of the first conveyer 11.

In the mixing apparatus 1, the powder 90 is supplied into the powder forming mechanism 20 located at the first conveyer 11. The powder 90 is formed by the powder forming mechanism 20, and conveyed from the powder forming mechanism 20 to the downstream end portion 11b of the first conveyer 11. The powder 90 falls from the downstream end portion 11b of the first conveyer 11. The second conveyer 12 conveys the powder dropped from the first conveyer 11. The powder 90 is sprayed with liquid by the liquid spraying mechanism 30 in the process of being conveyed by the second conveyer 12.

The mixing apparatus 1 can reduce the irregularities that are formed on the surface of the powder 90 in the process of its formation by the powder forming mechanism 20 by dropping the powder 90 from the first conveyer 11 to the second conveyer 12. In this manner, the variation in the ratio between the powder 90 and the liquid sprayed by the liquid spraying mechanism 30 due to the irregularities formed on the surface of the powder 90 can be reduced.

The mixing apparatus 1 may include a first scraping plate 13 for scraping the powder 90 from the first conveyer 11. The first scraping plate 13 may be located at the downstream end portion 11b of the first conveyer 11. With the first scraping plate 13, the powder 90 adhering to the first conveyer 11 can be scraped and dropped to the second conveyer 12.

In addition, the mixing apparatus 1 may include a second scraping plate 14 for scraping the powder 90 from the second conveyer 12. The second scraping plate 14 may be located at the downstream end portion 12b of the second conveyer 12. With second scraping plate 14, the powder 90 adhering to the second conveyer 12 can be scraped and dropped from the downstream end portion 12b of the second conveyer 12. For example, a container (not illustrated in the drawing) that collects a mixture may be provided below the downstream end portion 12b. While the material of the first scraping plate 13 and the second scraping plate 14 is not particularly limited as long as the powder 90 can be scraped from the conveyer 10, metal materials such as stainless steel may be used, for example. The materials of the first scraping plate 13 and the second scraping plate 14 may be the same as or different from each other.

The material of the conveyance surface 11c in the first conveyer 11 may be rubber. In this manner, the slippage of the powder 90 on the conveyance surface 11c can be reduced. Accordingly, as described later, the powder 90 can be easily formed by the powder forming mechanism 20. The material of the conveyance surface 12c of the second conveyer 12 may be stainless steel. In this manner, the degradation of the conveyance surface 12c due to the liquid sprayed from the liquid spraying mechanism 30 described later can be reduced. It should be noted that the materials of the conveyance surfaces 11c and 12c are not limited to the above-mentioned examples. For example, both the conveyance surfaces 11c and 12c may be made of rubber or stainless steel.

The first conveyance speed of the powder 90 by the first conveyer 11 and the second conveyance speed of the powder 90 by the second conveyer 12 are required to be adjusted appropriately depending on the material of the powder 90, but may be 10 mm/s to 80 mm/s, for example. In the case where the conveyance speed is lower than 10 mm/s, the throughput per unit time is decreased, and accordingly the productivity of the mixture by the mixing apparatus 1 is reduced. In the case where the conveyance speed is higher than 80 mm/s, a control of uniformly spraying the liquid to the powder 90 in a laminar shape is difficult for the liquid spraying mechanism 30 described later.

The first conveyance speed and the second conveyance speed may be different from each other. In this case, the thickness of the powder 90 in the second conveyer 12 can be adjusted by the difference between first conveyance speed and second conveyance speed. For example, in the case where the second conveyance speed is higher than the first conveyance speed, the thickness of the powder 90 in the second conveyer 12 is smaller than the thickness of the powder 90 in the first conveyer 11. In the case where the second conveyance speed is lower than the first conveyance speed, the thickness of the powder 90 in the second conveyer 12 is greater than the thickness of the powder 90 in the first conveyer 11.

The powder forming mechanism 20 may be configured to be able to form the powder 90 into a laminar shape. As described above, the powder forming mechanism 20 may be located on the first conveyer 11. The powder forming mechanism 20 may include a first blade 21, a second blade 22, a first side wall 23, a second side wall 24, and a back wall 25.

The first blade 21 and the second blade 22 may be configured to be able to form the powder 90 in the height direction with respect to the conveyer 10. It should be noted that the number of blades provided in the powder forming mechanism 20 may be one or three or more. In the following description, the first blade 21 and the second blade 22 may be collectively simply referred to as blade.

The blade may have a plate-like shape extending along the width direction of the conveyer 10. The thickness of the blade in the conveyance direction in the vicinity of its lower end portion decreases toward the lower side. The material of the blade is not particularly limited as long as the powder 90 can be formed, but metal materials such as stainless steel may be used, for example.

The blade may have a flat plate shape with a constant thickness. In this case, the thickness of the blade may be 0.1 mm to 0.5 mm. In the case where the thickness of the blade is smaller than 0.1 mm, the blade that moves down toward the powder 90 is easily deformed by being pushed by the powder 90. In the case where the thickness of the blade is greater than 0.5 mm, the powder 90 is easily compressed under the blade by being pushed by the blade without expanding to the front and rear sides of the blade. In this case, the liquid is less likely to permeate the compressed powder 90.

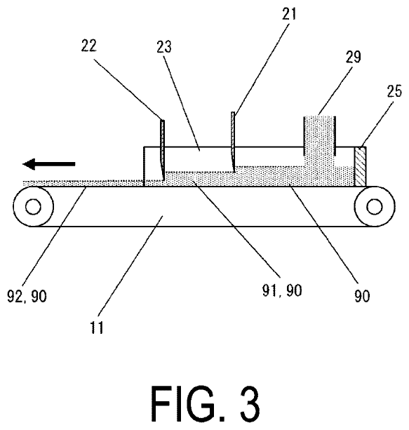

FIG. 3 is a sectional view taken along a line III-III in FIG. 2. FIG. 3 illustrates a configuration of the powder forming mechanism 20. In addition, FIG. 3 illustrates a powder supplying mechanism 29. The powder supplying mechanism 29 supplies the powder 90 to the region surrounded by the first side wall 23, the second side wall 24, the back wall 25, and the first blade 21. The powder supplying mechanism 29 may be a part of the mixing apparatus 1, or an apparatus separate from the mixing apparatus 1.

The heights of the first blade 21 and the second blade 22 during conveyance of the powder 90 by the conveyer 10 vary between a first height and a second height greater than the first height. Specifically, the first blade 21 and the second blade 22 may be configured to be able to move (vibrate) in the vertical direction. The mixing apparatus 1 may include a driving mechanism (not illustrated in the drawing) for varying the heights of the first blade 21 and the second blade 22.

The vertical movement of the blade may be continuous or intermittent. In the following description, the blade is assumed to move continuously in the vertical direction.

The first height of the blade is a lower limit of the thickness of the powder 90 formed with the blade. The second height of the blade is an upper limit of the thickness of the powder 90 formed with the blade. The surface of the powder formed with the blade has a wavy shape between the first height and second height of the blade in the conveyance direction.

The first blade 21 forms the powder 90 into a first formed body 91 such that the thickness of the powder 90 falls within a range between the first height and the second height of the first blade 21. The first formed body 91 is the same as the powder 90 in terms of material. The second blade 22 forms the first formed body 91 into a second formed body 92 such that the thickness of the powder 90 falls within a range between the first height and the second height of the second blade 22. The second formed body 92 is the same as the powder 90 and the first formed body 91 in terms of material.

In the case where the height of the blade is constant at the first height, the first formed body 91 is conveyed with its top surface in contact with the side surface of the first blade 21. The second formed body 92 is conveyed with its top surface in contact with the side surface of the second blade 22. In this case, there may be stagnation of the first formed body 91 and the second formed body 92 during their conveyance. The vertical movement of the blade can reduce such a stagnation and achieve smooth conveyance of the powder 90.

In some cases, the powder 90 may contain clumps that are larger than the first height of the blade and can be crushed by the blade. The blade crushes such clumps in the process of forming the powder 90. However, in the case where the powder 90 easily slips on the conveyance surface 11c, slippage of a clump of the powder 90 before the blade may form streaks on the formed body on the downstream side of the clump.

In the case where the material of the conveyance surface 11c is rubber as described above, the slippage of the powder 90 on the conveyance surface 11c can be reduced. Thus, the powder 90 can be formed into a laminar shape by crushing the clump of the powder 90 with the blade.

A first height of a blade located on the downstream side in the conveyance direction may be smaller than a first height of a blade located on the upstream side in the conveyance direction. In the examples illustrated in FIGS. 1 and 2, the first height of the second blade 22 may be smaller than the first height of the first blade 21. By forming the thickness of the powder 90 in stages with a plurality of blades, the powder 90 can be uniformly expanded in stages in the width direction, and the powder 90 can be formed with a constant thickness.

The thickness of the powder 90 formed by the second blade 22 is the final thickness of the powder 90 that is formed by the powder forming mechanism 20. The first height of the second blade 22 may be 4 mm or smaller, for example. In the case where the first height of the second blade 22 is greater than 4 mm, the liquid sprayed by the liquid spraying mechanism 30 is less likely to permeate to the lower side of the powder 90 formed by the second blade 22.

The cycle of the vertical movement of the blade depends on the conveyance speed of the powder 90 by the conveyer 10. In other words, the cycle of the vertical movement of the blade may be set relative to the movement distance of the powder 90, not relative to the time. More specifically, the powder 90 may move by 0.7 mm to 2.5 mm during a single vertical movement of the blade. The cycle of the vertical movement of the blade relative to time is set by the relationship between this distance and the conveyance speed of the powder 90.

In the case where the movement distance of the powder 90 during a single vertical movement of the blade is smaller than 0.7 mm, the efficiency in forming the powder 90 is reduced. In the case where the movement distance of the powder 90 during a single vertical movement of the blade is greater than 2.5 mm, the forming of the powder 90 is insufficient.

The movement distance of the powder 90 during a single vertical movement of the blade may differ depending on the first height of each blade. More specifically, the movement distance of the powder 90 during a single vertical movement of the blade with a larger first height may be longer in comparison with the blade with a smaller first height.

As described above, the blade crushes clumps of the powder 90 in the process of forming the powder 90. The blade with a larger first height crushes larger clumps in comparison with the blade with a smaller first height. Since the proportion of the number of such clumps is small, the movement distance of the powder 90 during a single vertical movement of the blade for crushing such clumps may be long.

For each blade, as the cycle of the vertical movement is shorter, the condition of a formed body of the powder 90 improves. Note that, as the cycle of the vertical movement is shorter, a load exerted on the driving mechanism of the blade increases. As such, the cycle of the vertical movement of the blade may be increased in accordance with the first height.

In each of the first blade 21 and the second blade 22, the difference (fluctuation range) between the first height and second height may be 2 mm to 4 mm. In the case where the fluctuation range is smaller than 2 mm, the powder 90 formed with each blade may not be smoothly conveyed. In the case where the fluctuation range is greater than 4 mm, the blade speed is excessive when the conveyance speed of the powder 90 and the cycle of the vertical movement of the blade are set as described above. As a result, the load on the driving mechanism for changing the blade height may increase, thus reducing the lifetime of the driving mechanism.

The respective fluctuation ranges of the heights of the first blade 21 and the second blade 22 may be the same as or different from each other. For example, the fluctuation range of the second blade 22 smaller than the fluctuation range of the first blade 21 can reduce the irregularity difference of the powder 90 in the conveyance direction.

The first height and second height of each of the first blade 21 and the second blade 22 may be set as appropriate such that the powder 90 is formed in stages. More specifically, the first height and second height of the second blade 22 are set to the lower limit and upper limit of the final thickness of the powder 90, respectively. The first height and second height of the first blade 21 may be set to be greater than the first height and second height of the second blade 22, respectively, by 0 mm to 4 mm. In the case where three or more blades are provided, the difference in the first height and the difference in the second height between adjacent blades may each be set to 0 mm to 4 mm.

The first side wall 23 may extend along the conveyance direction of the powder 90 by the conveyer 10. The second side wall 24 may face the first side wall 23. That is, the first side wall 23 and the second side wall 24 are side walls provided at opposite ends of the conveyance region of the powder 90 in the width direction. The first side wall 23 and the second side wall 24 may be located on opposite sides of the first blade 21 and the second blade 22. The first side wall 23 and the second side wall 24 are provided in contact with the conveyance surface 11c of the conveyer 10.

The powder 90 conveyed by the first conveyer 11 is formed by the blade in the height direction. Further, the powder 90 is formed by the first side wall 23 and the second side wall 24 in the width direction. As a result, variation in the amount of the powder 90 per unit length in the conveyance direction can be reduced. Thus, the ratio between the powder 90 and the liquid sprayed by the liquid spraying mechanism 30 can be uniformed.

The back wall 25 is located on the upstream side of the first side wall 23 and the second side wall 24 in the conveyance direction. In the mixing apparatus 1, the powder supplying mechanism 29 may supply the powder 90 to the region defined by the first side wall 23, the second side wall 24, the back wall 25, and the first blade 21. Specifically, the back wall 25 defines the end portion on the upstream side of the region to which the powder 90 is supplied in the conveyance direction. Note that in the mixing apparatus 1, the back wall 25 may be omitted.

The liquid spraying mechanism 30 sprays liquid to the powder 90 formed into a laminar shape. The liquid is, for example, a vehicle or solvent that is added to the powder 90 composed of ceramic particles. Specific examples of the liquid may include aqueous solution of water-soluble acrylic resin or polysaccharide. The liquid spraying mechanism 30 may be located downstream of the powder forming mechanism 20 in the conveyance direction of the powder 90 by the first conveyer 11. The liquid spraying mechanism 30 may be located above the second conveyer 12. In FIGS. 1 and 2, the mixing apparatus 1 includes two liquid spraying mechanisms 30 aligned in the width direction. Note that, the number of the liquid spraying mechanisms 30 provided in the mixing apparatus 1 is not limited to two as long as liquid can be sprayed to the entirety of the powder 90 conveyed by the second conveyer 12.

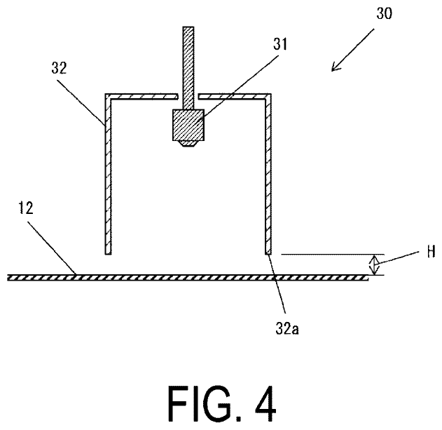

FIG. 4 is a sectional view taken along a line IV-IV in FIG. 2. FIG. 4 illustrates a structure of one liquid spraying mechanism 30. As illustrated in FIG. 4, the liquid spraying mechanism 30 may include a nozzle 31 and a cover 32.

The nozzle 31 may be configured to be able to spray liquid to the powder 90 on the conveyer 10. The nozzle 31 may be a so-called single-fluid nozzle that jets only liquid. If the nozzle 31 is a so-called two-fluid nozzle that jets liquid and air, the air jetted from the nozzle 31 may cause the powder 90 to scatter. The nozzle 31 that serves as a single-fluid nozzle can reduce such a scatter of the powder 90. The nozzle 31 may be connected to a pump (not illustrated in the drawing) or the like that supplies liquid. The spray amount of liquid from the nozzle 31 may be determined as appropriate in consideration of a desired ratio between the powder 90 and the liquid, the conveyance speed of the powder 90 by the conveyer 10, and the amount of the powder 90 per unit length in the conveyance direction, and other factors.

The cover 32 limits the spray area of liquid from the nozzle 31. The cover 32 may have a cylindrical shape with a top surface where the nozzle 31 is attached and a lateral surface that limits the spray area of liquid. The nozzle 31 may be located on the central axis of the cylindrical shape of the cover 32. Note that, the shape of the cover 32 is not limited to this.

As viewed from the direction perpendicular to the conveyance surface 12c, the conveyance region of the powder 90 includes the entirety of the cover 32. In this manner, the liquid sprayed from the nozzle 31 toward the outside of the spray area of liquid limited by the cover 32 hits the lateral surface of the cover 32 and falls toward the powder 90 located below the cover 32. This reduces the possibility that liquid is sprayed to the outside of the region where the powder 90 is present on the conveyer 10, for example. Therefore, the area where the liquid is sprayed from the nozzle 31 can be limited to the region where the powder 90 is present, resulting in a uniform ratio between the powder 90 and the liquid.

The material of the cover 32 may be a material that does not react with the liquid. In addition, the material of the cover 32 may be a material with high water-repellency. Specific examples of the material of the cover 32 may include stainless steel and fluororesin.

A height H of an end portion 32a of the cover 32 with respect to the conveyer 10 may be set to be greater by 1 mm to 6 mm than the thickness of the formed powder 90. For example, in the case where the thickness of the formed powder 90 is set to 4 mm, the height H of the end portion 32a with respect to the conveyer 10 may be 5 mm to 10 mm. If H is smaller than 5 mm, the powder 90 is more likely to make contact with the cover 32 in the case where there is variation in the thickness of the powder 90. If H is greater than 10 mm, the liquid may possibly be sprayed to the outside from a gap between the powder 90 and the end portion 32a. That is, the spray area of liquid cannot be sufficiently limited.

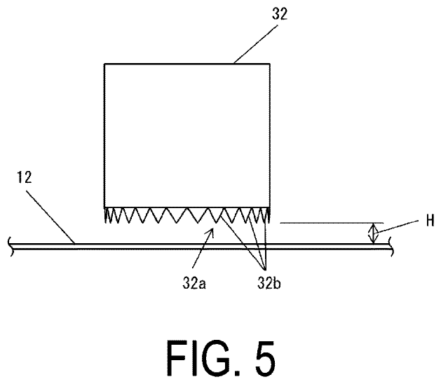

FIG. 5 is a side view of the cover 32. As illustrated in FIG. 5, the end portion 32a of the cover 32, which faces the conveyer 10, may include a plurality of protrusions 32b protruding toward the conveyer 10. The protrusions 32b may be located over the entirety of the end portion of the cover 32 which faces the conveyer 10. In other words, the end portion 32a may have a saw-tooth shape over its entirely. For simplicity's sake, in FIG. 5, only some of the protrusions 32b are denoted by the reference numeral. The above-described H represents the height of the lower end of the protrusions 32b with respect to the conveyer 10.

Since the cover 32 has such a shape, the liquid adhering to the cover 32 falls in a dispersed manner to the powder 90 from each of the plurality of protrusions 32b. Therefore, this reduces the deviation of the spray amount of the liquid to the powder 90 by location in comparison with the case where liquid adhering to the cover 32 falls to the powder 90 from a single point of the end portion 32a, for example.

Note that, the end portion 32a may not be necessarily provided with the protrusions 32b over its entirety facing the conveyer 10. As long as at least a part of the end portion 32a includes the protrusions 32b, the deviation of the spray amount of the liquid can be reduced in comparison with the case where the protrusions 32b are not provided.

The moving mechanism 40 may be configured to be able to move the powder 90 on the conveyance surface 12c in a direction different from the conveyance direction. The moving mechanism 40 is located downstream of the liquid spraying mechanism 30 in the conveyance direction. The moving mechanism 40 may move the powder 90 sprayed with liquid by the liquid spraying mechanism 30 in a direction of reducing the width of the conveyance region of the powder 90.

The nozzle 31 may spray the liquid within a circular area such that the amount of liquid is smaller near the center and larger near the outer edge, for example. In the state where the liquid has been sprayed by the liquid spraying mechanism 30 provided with that nozzle 31, the ratio of the liquid to the powder 90 tends to be higher at the center of the conveyance region of the powder 90 than at the end portions in the width direction. By moving the powder 90 from the end portion side toward the central side in the width direction with the moving mechanism 40, the powder 90 and liquid can be uniformly mixed.

In the first embodiment, the moving mechanism 40 may include four rotating bodies 41, 42, 43 and 44. At least a part of each rotating body 41 may be located above the conveyer 10, more specifically, the second conveyer 12. In FIGS. 1 and 2, the entirety of the rotating bodies 41 to 44 is located above the second conveyer 12.

The rotating bodies 41 to 44 are only required to have a material that does not react with the powder 90 or the liquid sprayed by the liquid spraying mechanism 30. The material of the rotating bodies 41 to 44 may be fluororesin or polyacetal, for example. In the case where the rotating bodies 41 to 44 are made of such a material, the adhesion of the mixture of liquid and the powder 90 is low. The rotating bodies 41 to 44 have wear resistance. Further, the rotating bodies 41 to 44 are less likely to damage the stainless steel making up the conveyance surface 12c.

The rotating bodies 41 to 44 are located above the conveyer 10 and across the end portions of the conveyance region of the powder 90 in the width direction. In addition, the rotating bodies 41 to 44 rotate in the direction of moving the powder 90 to the vicinity of the center of the second conveyer 12 on the upstream side in the conveyance direction. As a result, the powder 90 located near the end portions of the conveyance region of the powder 90 moves to the vicinity of the center of that region.

More specifically, the rotating bodies 41 and 42 are disposed side by side in the width direction at the same position in the conveyance direction. The rotating bodies 41 and 42 are located at respective ends of the conveyance region of the powder 90 in the width direction. The rotating body 43 is located on one end side of the conveyance region of the powder 90 in the width direction on the downstream side of the rotating bodies 41 and 42 in the conveyance direction. The rotating body 44 is located on the opposite side of the conveyance region of the powder 90 to the rotating body 43 in the width direction on the downstream side of the rotating body 43 in the conveyance direction. That is, the rotating bodies 43 and 44 are displaced from each other in the width direction. In this manner, each rotating body 41 can move the powder 90 from the end portion side toward the central side of the conveyer 10 so as to more uniformly mix the powder 90 and liquid.

The rotating body 43 is located on the most downstream side on one side in the width direction of the conveyance region of the powder 90. The rotating body 44 is located on the most downstream side on the opposite side of the conveyance region of the powder 90 to the rotating body 43 in the width direction. The rotating bodies 43 and 44 may be at least partially located at the substantial center in the width direction of the conveyance region of the powder 90 on the upstream side of the moving mechanism 40. For example, in the conveyance region of the powder 90 on the upstream side of the moving mechanism 40, a region from the center to one-eighth or less of the length of that conveyance region in the width direction may be regarded as a substantial center.

The rotational speed of the rotating bodies 41 to 44 may be 100% to 500% of the conveyance speed of the powder 90 by the second conveyer 12. The rotational speed of the rotating bodies 41 to 44 described herein is a movement speed at a given point located on the outer edge of the rotating bodies 41 to 44 in the circumferential direction of the rotating bodies 41 to 44.

If the rotational speed of the rotating bodies 41 to 44 is lower than 100% of the conveyance speed of powder, detachment property of the mixture of liquid and the powder 90 from the rotating bodies 41 to 44 degrades. Specifically, as the rotational speed of the rotating bodies 41 to 44 is lower, the mixture remains in contact with the surface of the rotating bodies 41 to 44 for a longer time. As a result, the cumulative pressure value due to the subsequent mixture conveyed by the second conveyer 12 increases, and the detachment property of the mixture from the rotating bodies 41 to 44 degrades. In particular, if the rotational speed of the rotating bodies 41 to 44 is lower than 100% of the conveyance speed of powder, the detachment property of the mixture from the rotating bodies 41 to 44 degrades to a level that hinders the operation of the mixing apparatus 1.

If the rotational speed of the rotating bodies 41 to 44 is higher than 500% of the conveyance speed of the powder 90, the difference between the conveyance speed of the powder 90 by the second conveyer 12 and the rotational speed of the rotating bodies 41 to 44 is excessive. As a result, the rotating bodies 41 to 44 wear, and the shear load on the mixture increases.

The rotation axes of the rotating bodies 41 to 44 may be substantially perpendicular to the conveyance surface 12c. For example, when the inclination of the rotation axis to a direction perpendicular to the conveyance surface is 5° or smaller, the rotation axis can be considered to be substantially perpendicular to the conveyance surface 12c.

The cross-sectional shape of the rotating bodies 41 to 44 on the plane including the rotation axis may be an isosceles trapezoid with its upper side shorter than its lower side. With the rotating bodies 41 to 44 having such a cross section, the mixture of liquid and the powder 90 can be easily detached from the second conveyer 12. As the upper side in the above-mentioned cross section is shorter, the detachment property improves. On the other hand, as the upper side in the above-mentioned cross section is shorter, the effect of mixing the powder 90 and liquid is reduced. Note that, the cross-sectional shape of the rotating body 41 is not limited to this, and may be a rectangular shape, for example.

The moving mechanism 40 is not limited to the configuration including the four rotating bodies 41 to 44. In the case where the moving mechanism 40 includes a rotating body, the moving mechanism 40 may include at least one rotating body on each side of the conveyance region of the powder 90 in the width direction. Further, the moving mechanism 40 is not limited to the configuration including a rotating body.

The control unit 50 may be configured to be able to control the operations of respective units of the mixing apparatus 1 in an integrated manner. For example, the control unit 50 may control the vertical movement of the first blade 21 and the second blade 22 by controlling the driving mechanism. The control unit 50 may control the conveyance speed of the powder 90 by the first conveyer 11 and the second conveyer 12. The control unit 50 may control the spray amount of liquid from the nozzle 31. The control unit 50 may control the rotational speed of the rotating bodies 41 to 44.

The storage unit 60 is a storage medium that stores information required for the control by the control unit 50. The storage unit 60 may store programs for the various controls described above, for example. Note that, the mixing apparatus 1 may not necessarily include the storage unit 60, and may be communicably connected to an external storage apparatus having information stored therein which is required for the control by the control unit 50.

### Method of Manufacturing Mixture

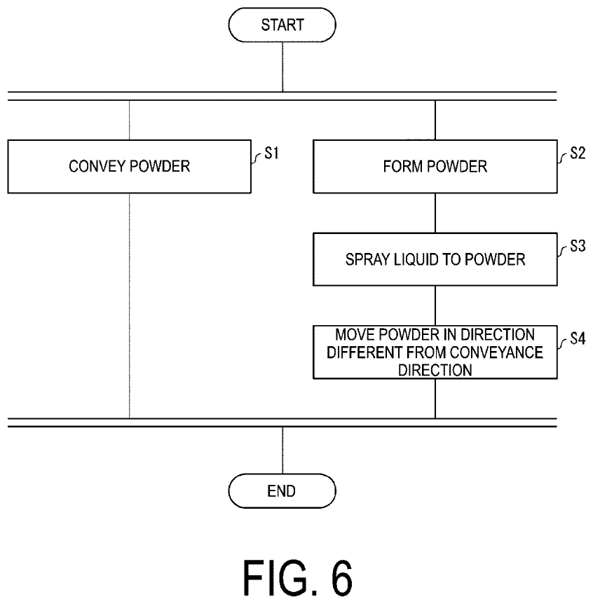

FIG. 6 is a flowchart illustrating an example of a method of manufacturing a mixture using the mixing apparatus 1. An example of the method of manufacturing a mixture using the mixing apparatus 1 is described below.

In the mixing apparatus 1, the control unit 50 conveys the powder 90 by the conveyer 10 (S1, conveyance step). The control unit 50 continues the conveyance of the powder 90 in the process of manufacturing the mixture.

The control unit 50 forms the powder 90 being conveyed in step S1 into a laminar shape by the powder forming mechanism 20 (S2, powder forming step). Subsequently, the control unit 50 sprays liquid by the liquid spraying mechanism 30 to the powder 90 formed into a laminar shape in step S2 (S3, liquid spray step). Further, the control unit 50 moves the powder 90 to which the liquid has been sprayed in step S3 in a direction different from the conveyance direction by the moving mechanism 40 (S4).

Through the above-described steps, the mixture can be manufactured using the mixing apparatus 1. Note that, the method of manufacturing the mixture using the mixing apparatus 1 is not limited to the above-mentioned examples. For example, the control unit 50 may intermittently perform the conveyance of the powder 90 by the conveyer 10.

### Example

A mixture of alumina powder and water-soluble acrylic resin was manufactured using the mixing apparatus 1. More specifically, alumina powder with a particle size of D50=1.5 μm was formed into a laminar shape with an average thickness of 3 mm by the powder forming mechanism 20. A aqueous solution containing 5 wt % of water-soluble acrylic resin (acrylic aqueous solution) was sprayed to the alumina powder in a laminar shape by the liquid spraying mechanism 30. The weight ratio between the alumina powder and the acrylic aqueous solution was set to 81:19.

The mixture obtained under the above-mentioned conditions was in a granular form. The mixture can be formed into a desired shape, for example, by a well-known pressing method using a metal mold.

In the mixture obtained under the above conditions, the volume fraction of alumina powder was 52.2 vol % and the volume fraction of acrylic solution was 47.8 vol %. Since the fluidity of the mixture with such volume fractions is low, a mixture with the same volume fractions is difficult to be kneaded by, for example, a kneader equipped with a conventionally known rotating vane. In other words, the mixing apparatus 1 can obtain a mixture with a high volume fraction of powder, which is difficult to be kneaded by a conventionally known kneader.

A method to obtain ceramic structures of desired shape is to form a mixture of powdered ceramic and liquid containing a binder, and then remove the binder by firing. Firing of the mixture is performed at a temperature of 300 °C or higher. At this time, the binder is released into the atmosphere as carbon dioxide and water.

In the mixing apparatus 1, the amount of carbon dioxide emitted during the manufacturing process of ceramic structures can be reduced by manufacturing a mixture with a small amount of binder. This effect, for example, contributes to the achievement of Goal 13 of the Sustainable Development Goals (SDGs) proposed by the United Nations, “Take concrete measures against climate change,” etc.

### Second Embodiment

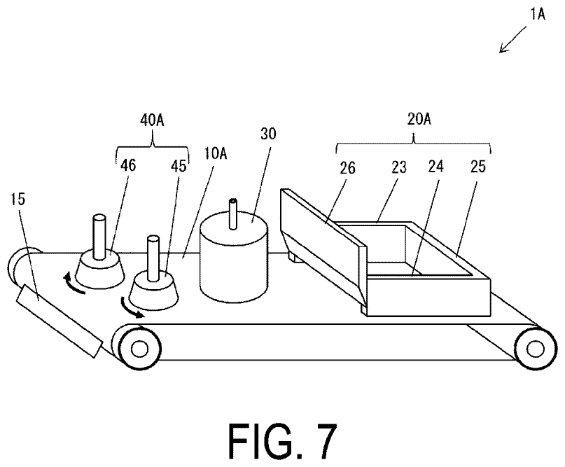

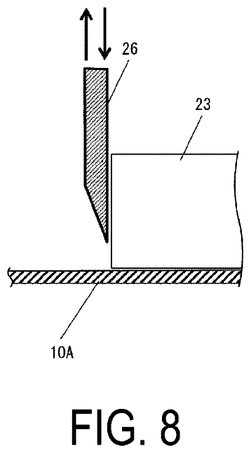

FIG. 7 is a perspective view illustrating a configuration of a mixing apparatus 1A according to a second embodiment. FIG. 8 is a sectional view illustrating a configuration of a powder forming mechanism 20A. As illustrated in FIGS. 7 and 8, the mixing apparatus 1A includes a conveyer 10A, a powder forming mechanism 20A, and a moving mechanism 40A.

The mixing apparatus 1A includes a liquid spraying mechanism 30 with the same structure as that of the liquid spraying mechanism 30 provided in the mixing apparatus 1. Note that, the mixing apparatus 1 includes two liquid spraying mechanisms 30, whereas the mixing apparatus 1A includes only one liquid spraying mechanism 30. The mixing apparatus 1A may further include a control unit that controls the conveyer 10A, the powder forming mechanism 20A, the liquid spraying mechanism 30, and the moving mechanism 40A, and a storage unit. The control unit and the storage unit are not illustrated in the drawing.

The conveyer 10A conveys powder. The conveyer 10A differs from the conveyer 10 in that the conveyer 10A is a single conveyer not including the first conveyer 11 or the second conveyer 12. As such, the powder forming mechanism 20A, the liquid spraying mechanism 30, and the moving mechanism 40A are located above the single conveyer.

A third scraping plate 15 for scraping powder from the conveyer 10A may be provided at a downstream end portion of the conveyer 10A in the conveyance direction. With the third scraping plate 15, the powder can be scraped from the conveyer 10A and dropped from the end portion of the conveyer 10A. A container for collecting the mixture may be provided below the end portion of the conveyer 10A, for example.

The powder forming mechanism 20A forms the powder into a laminar shape. The powder forming mechanism 20A differs from the powder forming mechanism 20 in that the powder forming mechanism 20A does not include the first blade 21 or the second blade 22, but only includes a single third blade 26 (blade).

The height of the third blade 26 varies between a first height and a second height greater than the first height during the conveyance of powder by the conveyer 10A. The third blade 26 forms the powder at the first height of the third blade 26.

In the powder forming mechanism 20A, the height of the powder formed by the third blade 26 is the final height of the powder to be formed. In this manner, the first height of the third blade 26 is set to the final height of the powder to be formed.

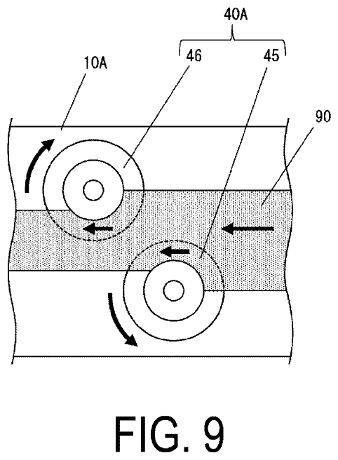

FIG. 9 is a plan view illustrating the moving mechanism 40A and its surroundings. On the conveyance surface where powder is conveyed by the conveyer 10A, the moving mechanism 40A moves the powder in a direction different from the conveyance direction of the powder to be conveyed by the conveyer 10A. The moving mechanism 40A differs from the moving mechanism 40 in that the moving mechanism 40A includes two rotating bodies 45 and 46. The rotating body 45 is located on one side of the conveyance region of the powder 90 in the width direction. The rotating body 46 is located on the opposite side of the conveyance region of the powder 90 to the rotating body 45 in the width direction.

As described above, the mixing apparatus 1A has a simplified configuration in comparison with the mixing apparatus 1. Even with this mixing apparatus 1A, a mixture of powder and liquid with a high volume fraction of powder can be obtained. Therefore, for example, the amount of binder to be used in the manufacturing process of ceramic structures can be reduced, and the amount of carbon dioxide emissions can also be reduced.

The invention according to the present disclosure has been described above based on various drawings and example. However, the invention according to the present disclosure is not limited to the embodiments described above. That is, the invention according to the present disclosure can be modified in various ways within the scope described in the present disclosure, and embodiments obtained by combining technical means disclosed in the different embodiments as appropriate are also included in the technical scope of the invention according to the present disclosure. In other words, it should be noted that a person skilled in the art can easily make various variations or modifications based on the present disclosure. It should also be noted that these variations or modifications are included in the scope of the present disclosure.

For example, conveyance side walls may be provided at opposite ends in the width direction on the downstream side of the powder forming mechanism 20. The conveyance side walls are provided in contact with the conveyance surface 11c (12c) of the conveyer 10. With the conveyance side walls provided on the conveyance surface 11c (12c) in this manner, the length of the powder in the width direction, which is ejected from the powder forming mechanism 20, can be controlled to be constant. Thus, a change of the length of the powder in the width direction due to the influence of vibration during conveyance and the like is reduced, and as a result variation in the thickness of powder can be reduced.

In the case where a rotating body is provided as the moving mechanism 40 on one end side of the conveyance region of the powder 90 in the width direction, a moving mechanism side wall may be provided on the other end side thereof in the width direction. In this case, the moving mechanism side wall can reduce spreading of the powder 90 passing through the rotating body to the other end portion in the width direction.

1. A mixing apparatus comprising:
a conveyer configured to convey powder;
a powder forming mechanism configured to form the powder into a laminar shape; and
a liquid spraying mechanism configured to spray liquid to the powder formed into a laminar shape, wherein
the powder forming mechanism comprises one or more blades configured to form the powder in a height direction with respect to the conveyer, and
a height of each of the blades with respect to the conveyer varies between a first height and a second height greater than the first height during conveyance of the powder by the conveyer.

2. The mixing apparatus according to claim 1, wherein the powder forming mechanism further comprises:
a first side wall extending along a conveyance direction of the powder by the conveyer, and
a second side wall facing the first side wall.

3. The mixing apparatus according to claim 2, wherein
the powder forming mechanism comprises a plurality of the blades along a conveyance direction of the powder by the conveyer, and
the first height of a blade of the plurality of the blades, the blade being located on a downstream side in the conveyance direction, is smaller than the first height of a blade of the plurality of the blades, the blade being located on an upstream side in the conveyance direction.

4. The mixing apparatus according to claim 1, wherein the liquid spraying mechanism comprises:
a nozzle configured to spray the liquid to the powder on the conveyer, and
a cover configured to limit a spray area of the liquid.

5. The mixing apparatus according to claim 4, wherein an end portion of the cover facing the conveyer comprises a plurality of protrusions protruding toward the conveyer.

6. The mixing apparatus according to claim 1, wherein the conveyer comprises:
a first conveyer to which the powder is supplied, and
a second conveyer located below the first conveyer and configured to convey the powder dropped from the first conveyer.

7. The mixing apparatus according to claim 6, wherein a first conveyance speed of the powder by the first conveyer and a second conveyance speed of the powder by the second conveyer are different from each other.

8. The mixing apparatus according to claim 1, further comprising a moving mechanism downstream of the liquid spraying mechanism in the conveyance direction, the moving mechanism being configured to move the powder in a direction different from a conveyance direction of the powder by the conveyer on a conveyance surface where the conveyer conveys the powder.

9. The mixing apparatus according to claim 8, wherein the moving mechanism comprises a rotating body at least partially located above the conveyer.

10. A method of manufacturing a mixture using a mixing apparatus, the mixing apparatus comprising:
a conveyer configured to convey powder;
a powder forming mechanism configured to form the powder into a laminar shape; and
a liquid spraying mechanism configured to spray liquid to the powder formed into a laminar shape,
the powder forming mechanism comprising one or more blades configured to form the powder in a height direction with respect to the conveyer,
a height of each of the blades with respect to the conveyer varying between a first height and a second height greater than the first height during conveyance of the powder by the conveyer, the method comprising:
conveying the powder by the conveyer;
forming the powder being conveyed in the conveying into a laminar shape by the powder forming mechanism; and
spraying liquid by the liquid spraying mechanism to the powder formed into a laminar shape in the forming.
